(19) United States
(12) Patent Application Publication
(10) Pub. No.: US 2021/0318035 A1
(43) Pub. Date: Oct. 14, 2021

(54) GEOTHERMAL HEAT UTILIZATION SYSTEM

(71) Applicants: MITSUBISHI HEAVY INDUSTRIES THERMAL SYSTEMS, LTD., Tokyo (JP); University Public Corporation Osaka, Osaka-shi, Osaka (JP)

(72) Inventors: Rinnichi SAI, Tokyo (JP); Masanobu SAKAI, Tokyo (JP); Toru YAMAGUCHI, Tokyo (JP); Masaki NAKAO, Osaka (JP); Yasuhisa NAKASO, Osaka (JP)

(73) Assignees: MITSUBISHI HEAVY INDUSTRIES THERMAL SYSTEMS, LTD., Tokyo (JP); University Public Corporation Osaka, Osaka-shi, Osaka (JP)

(21) Appl. No.: 17/266,910

(22) PCT Filed: Aug. 14, 2019
(86) PCT No.: PCT/JP2019/031943

§ 371 Date: Feb. 8, 2021

(30) Foreign Application Priority Data
Aug. 14, 2018 (JP) 2018-152612

(51) Int. Cl. F24T 50/00; F24T 10/20

(52) U.S. Cl. CPC F24T 50/00; F24T 10/20

(57) ABSTRACT

A geothermal heat utilization system includes a well that includes an upper opening, a lower opening, a water chamber capable of storing underground water inside, and a pump provided inside the water chamber and capable of pumping underground water; and a water suction pipe that extends from the pump toward a heat exchanger, wherein the water chamber includes an upper suction valve capable of being opened and closed toward the upper opening and a lower suction valve capable of being opened and closed toward the lower opening, and wherein the geothermal heat utilization system is configured such that, when any one of the upper suction valve and the lower suction valve is opened, the other is closed.

### TECHNICAL FIELD

The present invention relates to a geothermal heat utilization system.

Priority is claimed on Japanese Patent Application No. 2018-152612, filed Aug. 14, 2018, the content of which is incorporated herein by reference.

### BACKGROUND ART

In recent years, a geothermal heat utilization system that pumps up underground water in an aquifer from a well and uses the underground water as a hot heat source or a cold heat source has been proposed.

In the related art, Patent Literature 1 discloses a geothermal heat utilization system that uses upper and lower aquifers in one well.

### CITATION LIST

### Patent Literature

[Patent Literature 1]

Japanese Unexamined Patent Application, First Publication No. H09-280689

### SUMMARY OF INVENTION

### Technical Problem

However, in the geothermal heat utilization system as in Patent Literature 1, when the upper and lower aquifers are used, it is necessary to provide two pumps in one well and the number of pumps increases.

An object of the present invention is to provide a geothermal heat utilization system capable of reducing the number of pumps in the utilization of the upper and lower aquifers.

### Solution to Problem

A geothermal heat utilization system according to a first aspect includes a heat exchanger; a well that includes an upper opening that opens in an upper aquifer, a lower opening that opens in a lower aquifer, a water chamber provided between the upper opening and the lower opening and capable of storing underground water inside, and a pump provided inside the water chamber and capable of pumping the underground water; and a water suction pipe that extends from the pump toward the heat exchanger, wherein the water chamber includes an upper suction valve capable of being opened and closed toward the upper opening and a lower suction valve capable of being opened and closed toward the lower opening, and wherein the geothermal heat utilization system is configured such that, when any one of the upper suction valve and the lower suction valve is opened, the other is closed.

According to the present aspect, since the underground water in the upper and lower aquifers can be pumped by the pump provided in the water chamber, the pump can be shared between the upper opening and the lower opening. Therefore, in the geothermal heat utilization system using the upper and lower aquifers, it is possible to reduce the number of pumps.

A geothermal heat utilization system according to a second aspect is the geothermal heat utilization system according to the first aspect which further includes a water injection pipe that extends from the heat exchanger toward the lower opening, wherein the well further includes an upper water injection valve capable of injecting water in the water injection pipe into the upper opening, and a lower water injection valve capable of injecting water in the water injection pipe into the lower opening.

According to the present aspect, since it is possible to inject the underground water while sucking the underground water from a well, the geothermal heat utilization system can prevent ground subsidence and ground rise.

A geothermal heat utilization system according to a third aspect is the geothermal heat utilization system according to the first or second aspect, wherein the water chamber further includes an upper surface packer covering an upper surface of the water chamber and a lower surface packer covering a lower surface of the water chamber and is capable of being sealed with respect to at least one of the upper opening and the lower opening.

According to the present aspect, it is possible to prevent the underground water of the upper aquifer and the underground water of the lower aquifer from being mixed with each other. Therefore, in the geothermal heat utilization system, blockage of the well is prevented when the upper aquifer and the lower aquifer are used.

A geothermal heat utilization system according to a fourth aspect is the geothermal heat utilization system according to the first or second aspect, wherein the water chamber further includes an all-surface packer covering all surfaces of the water chamber and is capable of being sealed with respect to at least one of the upper opening and the lower opening.

According to the present aspect, it is possible to prevent the underground water of the upper aquifer and the underground water of the lower aquifer from being mixed with each other. Therefore, in the geothermal heat utilization system, blockage of the well is prevented when the upper aquifer and the lower aquifer are used.

A geothermal heat utilization system according to a fifth aspect is the geothermal heat utilization system according to any one of the first to fourth aspects, wherein the well further includes an operating rod to which the upper suction valve and the lower suction valve are fixed and which is movable upward and downward.

According to the present aspect, it is possible to move the upper suction valve and the lower suction valve upward and downward by moving the operating rod upward and downward. Therefore, in the geothermal heat utilization system, an opening and closing operation of the upper suction valve and the lower suction valve is easy.

### Advantageous Effects of Invention

According to the aspect of the present invention, in the utilization of the upper and lower aquifers, it is possible to reduce the number of pumps.

### BRIEF DESCRIPTION OF DRAWINGS

FIG. 1 is a system diagram of a geothermal heat utilization system according to an embodiment of the present invention.

FIG. 2 is an enlarged view of part II of FIG. 1.

FIG. 3 is a cross-sectional view of a well in a modification example of the embodiment according to the present invention.

FIG. 4 is a front view of a valve body in a modification example of the embodiment according to the present invention.

FIG. 5 is a front view of a valve body in a modification example of the embodiment according to the present invention.

### DESCRIPTION OF EMBODIMENTS

Hereinafter, an embodiment according to the present invention will be described using the accompanying drawings. The same or corresponding configurations are designated by the same reference numerals in all drawings, and common description will be omitted.

### EMBODIMENT

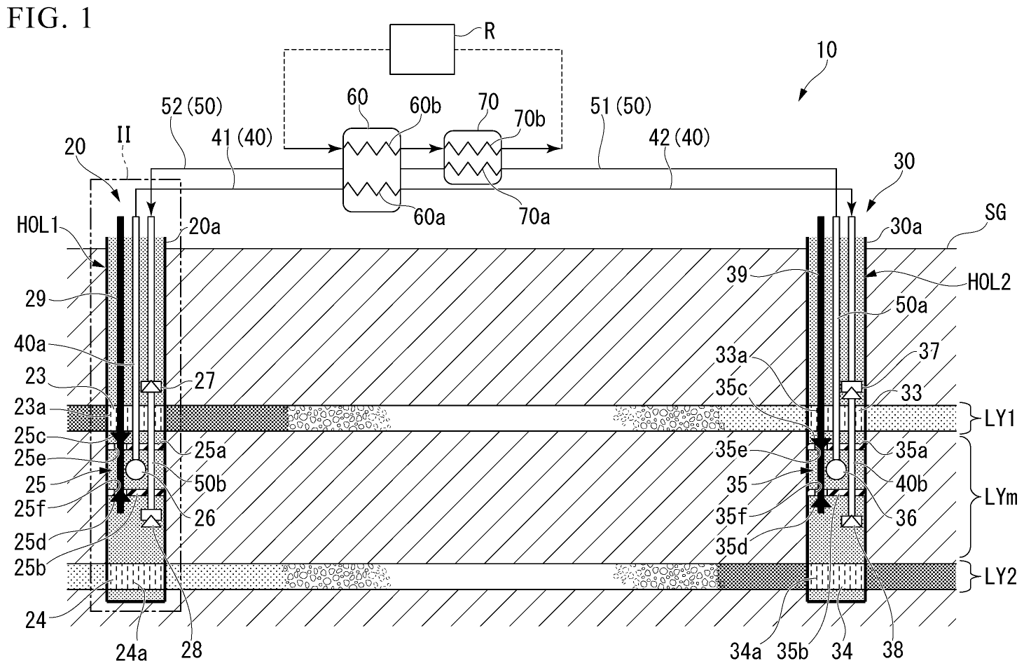

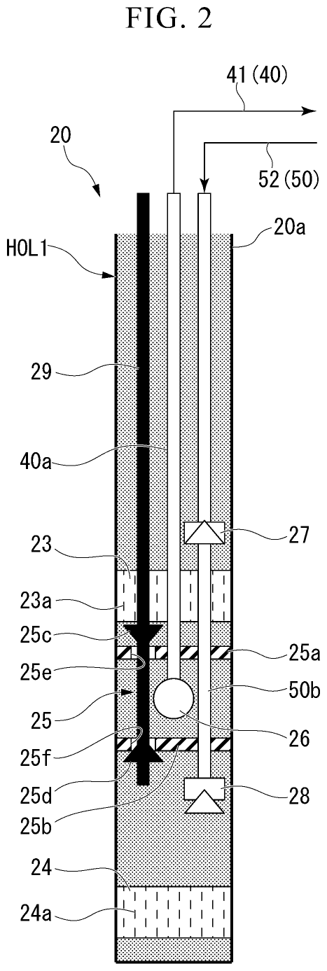

An embodiment of a geothermal heat utilization system according to the present invention will be described with reference to FIGS. 1 and 2.

The arrows shown in FIGS. 1 and 2 indicate the flow of a refrigerant (including underground water) in each portion.

### (Configuration of Geothermal Heat Utilization System)

A geothermal heat utilization system 10 stores heat in two different aquifers, an upper aquifer LY1 and a lower aquifer LY2. The upper aquifer LY1 and the lower aquifer LY2 are formed, for example, with a diluvial clay layer LYm interposed therebetween.

As shown in FIG. 1, the geothermal heat utilization system 10 includes a first well 20 and a second well 30.

The geothermal heat utilization system 10 further includes a first pipe 40, a second pipe 50, a first heat exchanger 60, and a second heat exchanger 70.

### (Configuration of First Heat Exchanger)

A primary side (a primary side pipe 60a) of the first heat exchanger 60 is connected in the middle of the first pipe 40.

A secondary side (a secondary side pipe 60b) of the first heat exchanger 60 is connected to a load R such as an air conditioner.

The first heat exchanger 60 can exchange heat between the primary side and the secondary side.

### (Configuration of Second Heat Exchanger)

A primary side (a primary side pipe 70a) of the second heat exchanger 70 is connected in the middle of the second pipe 50.

A secondary side (a secondary side pipe 70b) of the second heat exchanger 70 is connected to the load R.

The second heat exchanger 70 can exchange heat between the primary side and the secondary side.

The secondary side pipe 70b of the second heat exchanger 70 and the secondary side pipe 60b of the first heat exchanger 60 are connected in series.

### (Configuration of First Well)

The first well 20 is a well that penetrates the upper aquifer LY1 and extends to the lower aquifer LY2 from above ground to underground.

The first well 20 includes a first upper opening 23, a first lower opening 24, a first water chamber 25, and a first pump 26.

The first well 20 may further include a casing 20a embedded in an excavation hole HOL1 obtained by excavating the underground from a ground surface SG to the lower aquifer LY2.

The first well 20 may further include a first upper water injection valve 27 capable of injecting water into the first upper opening 23, a first lower water injection valve 28 capable of injecting water into the first lower opening 24, and a first operating rod 29.

The first upper opening 23 opens in the upper aquifer LY1.

The first upper opening 23 is a portion of the first well 20 located at a depth corresponding to the upper aquifer LY1.

The underground water is stored in the first upper opening 23.

For example, the casing 20a is provided with a strainer 23a constituted by a plurality of slits in the upper aquifer LY1. The first upper opening 23 is configured such that the underground water in the upper aquifer LY1 can be taken into the inside of the casing 20a and the underground water can be returned to the upper aquifer LY1 from the inside of the casing 20a via the strainer 23a.

The first lower opening 24 opens in the lower aquifer LY2.

The first lower opening 24 is a portion of the first well 20 located at a depth corresponding to the lower aquifer LY2.

The underground water is stored in the first lower opening 24.

The first upper opening 23 and the first lower opening 24 are arranged vertically.

For example, the casing 20a is provided with a strainer 24a constituted by a plurality of slits in the lower aquifer LY2. The first lower opening 24 is configured such that the underground water in the lower aquifer LY2 can be taken into the inside of the casing 20a and the underground water can be returned to the lower aquifer LY2 from the inside of the casing 20a via the strainer 24a.

The first water chamber 25 is provided below the first upper opening 23 and above the first lower opening 24. That is, the first water chamber 25 is provided between the first upper opening 23 and the first lower opening 24.

The first water chamber 25 is configured to be able to store the underground water inside.

The first water chamber 25 can be sealed with respect to at least any one of the first upper opening 23 and the first lower opening 24.

The first water chamber 25 includes an upper surface packer 25a, a lower surface packer 25b, an upper suction valve 25c, and a lower suction valve 25d.

The first water chamber 25 has an upper surface suction port 25e provided in the upper surface packer 25a and a lower surface suction port 25f provided in the lower surface packer 25b.

The upper surface packer 25a covers an upper surface in the casing 20a.

The lower surface packer 25b covers a lower surface in the casing 20a.

The upper surface packer 25a can be sealed between the first water chamber 25 and the first upper opening 23 such that the underground water does not leak therethrough.

The lower surface packer 25b can be sealed between the first water chamber 25 and the first lower opening 24 such that the underground water does not leak therethrough.

The upper suction valve 25c can be opened and closed toward the first upper opening 23.

When the upper suction valve 25c is opened, the first water chamber 25 can suck the underground water stored in the first upper opening 23 through the upper surface suction port 25e.

When the upper suction valve 25c is closed, the first water chamber 25 is sealed with respect to the first upper opening 23.

The lower suction valve 25d can be opened and closed toward the first lower opening 24.

When the lower suction valve 25d is opened, the first water chamber 25 can suck the underground water stored in the first lower opening 24 through the lower surface suction port 25f.

When the lower suction valve 25d is closed, the first water chamber 25 is sealed with respect to the first lower opening 24.

The first pump 26 is provided inside the first water chamber 25.

The first pump 26 pumps the underground water inside the first water chamber 25 toward the first pipe 40.

The first upper water injection valve 27 can inject circulation water in the second pipe 50, which is supplied from the second heat exchanger 70 to the first well 20, into the first upper opening 23.

In the present embodiment, the first upper water injection valve 27 is provided above the first upper opening 23.

The first lower water injection valve 28 can inject circulation water in the second pipe 50, which is supplied from the second heat exchanger 70 to the first well 20, into the first lower opening 24.

In the present embodiment, the first lower water injection valve 28 is provided below the first water chamber 25 and above the first lower opening 24.

The first operating rod 29 is fixed to the upper suction valve 25c and the lower suction valve 25d.

The first operating rod 29 is vertically movable with respect to the upper surface packer 25a and the lower surface packer 25b.

In the present embodiment, the geothermal heat utilization system 10 is configured such that, when any one of the upper suction valve 25c and the lower suction valve 25d is opened, the other is closed, by the first operating rod 29.

That is, when the first operating rod 29 is moved upward, the upper suction valve 25c is opened and the lower suction valve 25d is closed.

Further, when the first operating rod 29 is moved downward, the upper suction valve 25c is closed and the lower suction valve 25d is opened.

### (Configuration of Second Well)

The second well 30 is a well that penetrates the upper aquifer LY1 and extends to the lower aquifer LY2 from above ground to underground.

The second well 30 includes a second upper opening 33, a second lower opening 34, a second water chamber 35, and a second pump 36.

The second well 30 may further include a casing 30a embedded in an excavation hole HOL2 obtained by excavating the underground from a ground surface SG to the lower aquifer LY2.

The second well 30 may further include a second upper water injection valve 37 capable of injecting water into the second upper opening 33, a second lower water injection valve 38 capable of injecting water into the second lower opening 34, and a second operating rod 39.

The second upper opening 33 opens in the upper aquifer LY1.

The second upper opening 33 is a portion of the second well 30 located at a depth corresponding to the upper aquifer LY1.

The underground water is stored in the second upper opening 33.

For example, the casing 30a is provided with a strainer 33a constituted by a plurality of slits in the upper aquifer LY1. The second upper opening 33 is configured such that the underground water in the upper aquifer LY1 can be taken into the inside of the casing 30a and the underground water can be returned to the upper aquifer LY1 from the inside of the casing 30a via the strainer 33a.

The second lower opening 34 opens in the lower aquifer LY2.

The second lower opening 34 is a portion of the second well 30 located at a depth corresponding to the lower aquifer LY2.

The underground water is stored in the second lower opening 34.

The second upper opening 33 and the second lower opening 34 are arranged vertically.

For example, the casing 30a is provided with a strainer 34a constituted by a plurality of slits in the lower aquifer LY2. The second lower opening 34 is configured such that the underground water in the lower aquifer LY2 can be taken into the inside of the casing 30a and the underground water can be returned to the lower aquifer LY2 from the inside of the casing 30a via the strainer 34a.

The second water chamber 35 is provided below the second upper opening 33 and above the second lower opening 34. That is, the second water chamber 35 is provided between the second upper opening 33 and the second lower opening 34.

The second water chamber 35 is configured to be able to store the underground water inside.

The second water chamber 35 can be sealed with respect to at least any one of the second upper opening 33 and the second lower opening 34.

The second water chamber 35 includes an upper surface packer 35a, a lower surface packer 35b, an upper suction valve 35c, and a lower suction valve 35d.

The second water chamber 35 has an upper surface suction port 35e provided in the upper surface packer 35a and a lower surface suction port 35f provided in the lower surface packer 35b.

The upper surface packer 35a covers a lower surface in the casing 30a. The lower surface packer 35b covers a lower surface in the casing 30a.

The upper surface packer 35a can be sealed between the second water chamber 35 and the second upper opening 33 such that the underground water does not leak therethrough.

The lower surface packer 35b can be sealed between the second water chamber 35 and the second lower opening 34 such that the underground water does not leak therethrough.

The upper suction valve 35c can be opened and closed toward the second upper opening 33.

When the upper suction valve 35c is opened, the second water chamber 35 can suck the underground water stored in the second upper opening 33 through the upper surface suction port 35e.

When the upper suction valve 35c is closed, the second water chamber 35 is sealed with respect to the second upper opening 33.

The lower suction valve 35d can be opened and closed toward the second lower opening 34.

When the lower suction valve 35d is opened, the second water chamber 35 can suck the underground water stored in the second lower opening 34 through the lower surface suction port 35f.

When the lower suction valve 35d is closed, the second water chamber 35 is sealed with respect to the second lower opening 34.

The second pump 36 is provided inside the second water chamber 35.

The second pump 36 pumps the underground water inside the second water chamber 35 toward the second pipe 50.

The second upper water injection valve 37 can inject circulation water in the first pipe 40, which is supplied from the first heat exchanger 60 to the second well 30, into the second upper opening 33.

In the present embodiment, the second upper water injection valve 37 is provided above the second upper opening 33.

The second lower water injection valve 38 can inject circulation water in the first pipe 40, which is supplied from the first heat exchanger 60 to the second well 30, into the second lower opening 34.

In the present embodiment, the second lower water injection valve 38 is provided below the second water chamber 35 and above the second lower opening 34.

The second operating rod 39 is fixed to the upper suction valve 35c and the lower suction valve 35d.

The second operating rod 39 is vertically movable with respect to the upper surface packer 35a and the lower surface packer 35b.

In the present embodiment, the geothermal heat utilization system 10 is configured such that, when any one of the upper suction valve 35c and the lower suction valve 35d is opened, the other is closed, by the second operating rod 39.

That is, when the second operating rod 39 is moved upward, the upper suction valve 35c is opened and the lower suction valve 35d is closed.

Further, when the second operating rod 39 is moved downward, the upper suction valve 35c is closed and the lower suction valve 35d is opened.

### (Configuration of First Pipe)

The first pipe 40 extends from a first end 40a to a second end 40b via the primary side (the primary side pipe 60a) of the first heat exchanger 60.

The first pipe 40 includes a first water suction pipe 41 on the first end 40a side from the first heat exchanger 60 and a first water injection pipe 42 on the second end 40b side from the first heat exchanger 60.

The first water suction pipe 41 extends into the first well 20.

The first water suction pipe 41 extends from the first pump 26 to the first heat exchanger 60.

The first water suction pipe 41 penetrates the upper surface packer 25a and is connected to the first pump 26.

The underground water stored inside the first water chamber 25 can be pumped toward the first heat exchanger 60 through the first water suction pipe 41 by driving the first pump 26.

The first water injection pipe 42 extends into the second well 30.

The first water injection pipe 42 extends from the first heat exchanger 60 toward the second lower opening 34.

The underground water pumped to the first heat exchanger 60 can be circulated toward the second well 30 through the first water injection pipe 42.

Therefore, the second upper water injection valve 37 can inject the underground water in the first water injection pipe 42 into the second upper opening 33.

Further, the second lower water injection valve 38 can inject the underground water in the first water injection pipe 42 into the second lower opening 34.

### (Configuration of Second Pipe)

The second pipe 50 extends from a first end 50a to a second end 50b via the primary side (the primary side pipe 70a) of the second heat exchanger 70.

The second pipe 50 includes a second water suction pipe 51 on the first end 50a side from the second heat exchanger 70 and a second water injection pipe 52 on the second end 50b side from the second heat exchanger 70.

The second water suction pipe 51 extends into the second well 30.

The second water suction pipe 51 extends from the second pump 36 to the second heat exchanger 70.

The second water suction pipe 51 penetrates the upper surface packer 35a and is connected to the second pump 36.

The underground water stored inside the second water chamber 35 can be pumped to the second heat exchanger 70 through the second water suction pipe 51 by driving the second pump 36.

The second water injection pipe 52 extends into the first well 20.

The second water injection pipe 52 extends from the second heat exchanger 70 toward the first lower opening 24.

The underground water pumped to the second heat exchanger 70 can be circulated toward the first well 20 through the second water injection pipe 52.

Therefore, the first upper water injection valve 27 can inject the underground water in the second water injection pipe 52 into the first upper opening 23.

Further, the first lower water injection valve 28 can inject the underground water in the second water injection pipe 52 into the first lower opening 24.

### (Operation)

An operation of the geothermal heat utilization system 10 of the present embodiment will be described.

For example, as shown in FIG. 1, the first operating rod 29 is moved upward and the second operating rod 39 is moved downward.

In this case, in the first water chamber 25, the upper suction valve 25c is opened and the lower suction valve 25d is closed. On the other hand, in the second water chamber 35, the upper suction valve 35c is closed and the lower suction valve 35d is opened.

At that time, the first lower water injection valve 28 and the second upper water injection valve 37 may be opened, and the first upper water injection valve 27 and the second lower water injection valve 38 may be closed.

When the upper suction valve 25c is opened, the underground water stored in the first upper opening 23 is pumped toward the first heat exchanger 60 via the first water chamber 25 and the first pipe 40 by driving the first pump 26.

In the case of the present embodiment, hot water stored in the upper aquifer LY1 around the first upper opening 23 is pumped toward the first heat exchanger 60.

The hot water pumped toward the first heat exchanger 60 is heat-exchanged to become cold water.

The heat-exchanged cold water is stored in the upper aquifer LY1 around the second upper opening 33 via the first pipe 40, the second upper water injection valve 37, and the second upper opening 33.

When the lower suction valve 35d is opened, the underground water stored in the second lower opening 34 is pumped toward the second heat exchanger 70 via the second water chamber 35 and the second pipe 50 by driving the second pump 36.

In the case of the present embodiment, hot water stored in the lower aquifer LY2 around the second lower opening 34 is pumped toward the second heat exchanger 70.

The hot water pumped toward the second heat exchanger 70 is heat-exchanged to become cold water.

The heat-exchanged cold water is stored in the lower aquifer LY2 around the first lower opening 24 via the second pipe 50, the first lower water injection valve 28, and the first lower opening 24.

After the cold water is stored in each aquifer, the first operating rod 29 may be moved downward and the second operating rod 39 may be moved upward.

In this case, in the first water chamber 25, the lower suction valve 25d is opened and the upper suction valve 25c is closed. On the other hand, in the second water chamber 35, the lower suction valve 35d is closed and the upper suction valve 35c is opened.

At that time, the first lower water injection valve 28 and the second upper water injection valve 37 may be closed, and the first upper water injection valve 27 and the second lower water injection valve 38 may be opened.

Therefore, when the first operating rod 29 is moved downward and the second operating rod 39 is moved upward, the underground water circulates in a direction opposite to the above-described direction, and the cold water stored in each aquifer is consumed and the hot water is stored in each aquifer.

### (Operational Effects)

According to the geothermal heat utilization system 10 of the present embodiment, in the first well 20, the first pump 26 provided in the first water chamber 25 can pump water toward the first heat exchanger 60, and thus the pump can be shared between the first upper opening 23 and the first lower opening 24. Therefore, according to the geothermal heat utilization system 10, it is possible to reduce the number of pumps in the first well 20.

The same applies to the second well 30.

Further, according to the geothermal heat utilization system 10 of the present embodiment, in the first well 20, the first water chamber 25 is located between the first upper opening 23 and the first lower opening 24.

Therefore, for example, a water channel between the first lower opening 24 and the first pump 26 can be shortened as compared with the case in which the first water chamber 25 is above the first upper opening 23, and thus it is possible to prevent pressure loss.

The same applies to the second well 30.

Further, according to the geothermal heat utilization system 10 of the present embodiment, in the first well 20, the first water chamber 25 is located between the first upper opening 23 and the first lower opening 24.

Therefore, a water pressure equal to or higher than a water pressure in the first upper opening 23 is applied to a suction port of the first pump 26.

Thus, the geothermal heat utilization system 10 can maintain the water pressure at the suction port of the first pump 26.

The same applies to the second well 30.

Further, in the geothermal heat utilization system 10 of the present embodiment, each water suction valve, a first pump 26, and the like are provided in the first water chamber 25. Therefore, the first water chamber 25 can be easily pulled up even in the event of a failure.

Thus, the geothermal heat utilization system 10 is easy to maintain.

The same applies to the second well 30.

Further, in the first well 20, the geothermal heat utilization system 10 of the present embodiment can inject water into the first well 20 while sucking the underground water from the first well 20. Therefore, the geothermal heat utilization system 10 can prevent ground subsidence and ground rise.

The same applies to the second well 30.

Further, according to the geothermal heat utilization system 10 of the present embodiment, in the first well 20, the first water chamber 25 can be sealed with respect to at least one of the first upper opening 23 and the first lower opening 24. Therefore, the geothermal heat utilization system 10 can prevent the underground water of the upper aquifer LY1 and the underground water of the lower aquifer LY2 from being mixed with each other.

Therefore, in the geothermal heat utilization system 10, blockage of the first well 20 is prevented when the upper aquifer LY1 and the lower aquifer LY2 are used.

The same applies to the second well 30.

Further, the geothermal heat utilization system 10 of the present embodiment can supply the underground water of the upper aquifer LY1 and the underground water of the lower aquifer LY2 separately. Therefore, it is possible to prevent the underground water of the upper aquifer LY1 and the underground water of the lower aquifer LY2 from being mixed with each other.

Thus, in the geothermal heat utilization system 10 of the present embodiment, blockage of the well is further prevented when the upper aquifer LY1 and the lower aquifer LY2 are used.

In the first well 20 of the geothermal heat utilization system 10 of the present embodiment, it is possible to move the upper suction valve 25c and the lower suction valve 25d upward and downward by moving the first operating rod 29 upward and downward.

Therefore, in the geothermal heat utilization system 10 of the present embodiment, an opening and closing operation of the upper suction valve 25c and the lower suction valve 25d is easy.

The same applies to the second well 30.

Each water chamber in the geothermal heat utilization system 10 of the present embodiment includes the upper surface packer and the lower surface packer as packers, but each water chamber may have an all-surface packer that covers all surfaces (an upper surface, a lower surface, and a side peripheral surface) as a packer in the casing 20a.

The geothermal heat utilization system 10 of the present embodiment includes a first well 20 and a second well 30, but may be constituted by one well. In that case, water suction and water injection may be possible in one well.

### Modification Example

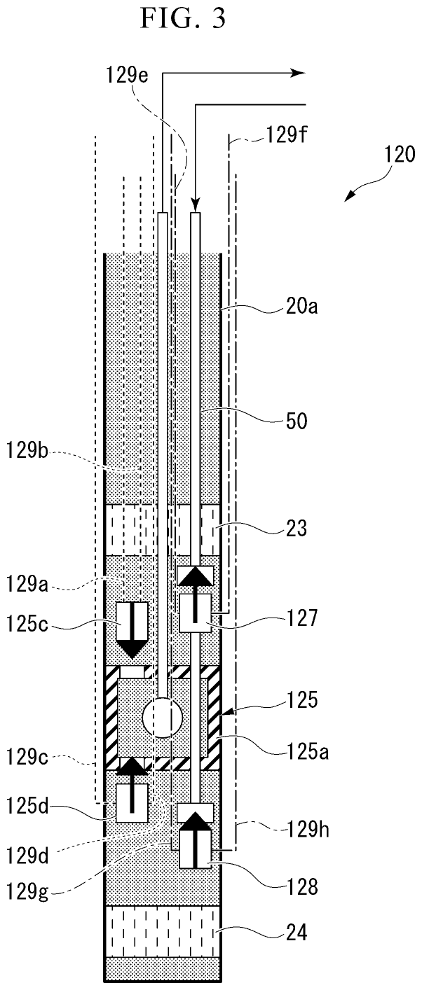

As a modification example of the first well 20 of the present embodiment, a first well 120 as shown in FIG. 3 may be provided.

The first well 120 may further include a first water chamber 125, a first upper water injection valve 127 capable of injecting water into the first upper opening 23, and a first lower water injection valve 128 capable of injecting water into the first lower opening 24.

The first water chamber 125 includes an all-surface packer 125a, an upper suction valve 125c, and a lower suction valve 125d.

The first well 120 further includes upper suction valve operating pipes 129a and 129b, and lower suction valve operating pipes 129c and 129d.

The upper suction valve operating pipes 129a and 129b can close the first water chamber 125 with the upper suction valve 125c when one is closed and water is injected into the other.

The lower suction valve operating pipes 129c and 129d can close the first water chamber 125 with the lower suction valve 125d when one is closed and water is injected into the other.

Further, upper water injection valve operating pipes 129e and 129f and lower water injection valve operating pipes 129g and 129h may be provided.

The upper water injection valve operating pipes 129e and 129f can close the second pipe 50 with the first upper water injection valve 127 when one is closed and water is injected into the other.

The lower water injection valve operating pipes 129g and 129h can close the second pipe 50 with the first lower water injection valve 128 when one is closed and water is injected into the other.

The all-surface packer 125a covers all surfaces (the upper surface, the lower surface, and the side peripheral surface) as a packer in the casing 20a.

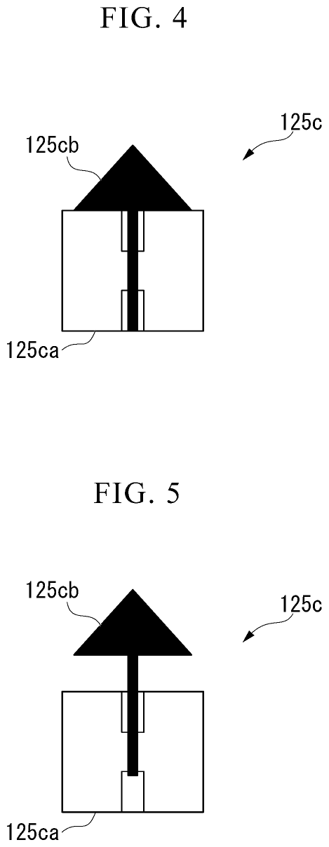

Further, the upper suction valve 125c may include a valve body support guide 125ca and a diaphragm 125cb as shown in FIG. 4. For example, the valve body support guide 125ca may be formed of a metal, and the diaphragm 125cb may be formed of rubber.

For example, when the upper water injection valve operating pipe 129e is closed and water is injected into the upper water injection valve operating pipe 129f, the diaphragm 125cb protrudes from the valve body support guide 125ca and closes the first water chamber 125 as shown in FIG. 5.

The same applies to the lower suction valve 125d, the first upper water injection valve 127, and the first lower water injection valve 128.

In addition, in FIGS. 3 to 5, the diaphragm 125cb is shown through the valve body support guide 125ca.

The above modification example can be similarly applied to the second well 30.

Although an embodiment of the present invention has been described above, this embodiment is shown as an example and is not intended to limit the scope of the invention. This embodiment can be implemented in various other forms, and various omissions, replacements, and changes can be made without departing from the gist of the invention. This embodiment and modification thereof are included in the scope of the invention described in the claims and the equivalent scope thereof in that they are included in the scope and gist of the invention.

### INDUSTRIAL APPLICABILITY

According to the aspect of the present invention, in the utilization of the upper and lower aquifers, it is possible to reduce the number of pumps.

### REFERENCE SIGNS LIST

10 Geothermal heat utilization system
20 First well
20a Casing
23 First upper opening
23a Strainer
24 First lower opening
24a Strainer
25 First water chamber
25a Upper surface packer
25b Lower surface packer
25c Upper suction valve
25d Lower suction valve
25e Upper surface suction port
25f Lower surface suction port
26 First pump
27 First upper water injection valve
28 First lower water injection valve
29 First operating rod
30 Second well
30a Casing
33 Second upper opening
33a Strainer
34 Second lower opening
34a Strainer
35 Second water chamber
35a Upper surface packer
35b Lower surface packer
35c Upper suction valve
35d Lower suction valve
35e Upper surface suction port
35f Lower surface suction port
36 Second pump
37 Second upper water injection valve
38 Second lower water injection valve
39 Second operating rod
40 First pipe
40a First end
40b Second end
41 First water suction pipe
42 First water injection pipe
50 Second pipe
50a First end
50b Second end
51 Second water suction pipe
52 Second water injection pipe
60 First heat exchanger
60a Primary side pipe
60b Secondary side pipe
70 Second heat exchanger
70a Primary side pipe
70b Secondary side pipe
120 First well
125 First water chamber
125a All-surface packer
125c Upper suction valve
125ca Valve body support guide
125cb Diaphragm
125d Lower suction valve
127 First upper water injection valve
128 First lower water injection valve
129a Upper suction valve operating pipe
129b Upper suction valve operating pipe
129c Lower suction valve operating pipe
129d Lower suction valve operating pipe
129e Upper water injection valve operating pipe
129f Upper water injection valve operating pipe
129g Lower water injection valve operating pipe
129h Lower water injection valve operating pipe
HOL1 Excavation hole
HOL2 Excavation hole
LY1 Upper aquifer
LY2 Lower aquifer
LYm Diluvial clay layer
R Load
SG Ground surface

1. A geothermal heat utilization system comprising:
a heat exchanger;
a well that includes an upper opening that opens in an upper aquifer, a lower opening that opens in a lower aquifer, a water chamber provided between the upper opening and the lower opening and capable of storing underground water inside, and a pump provided inside the water chamber and capable of pumping the underground water; and
a water suction pipe that extends from the pump toward the heat exchanger,
wherein the water chamber includes an upper suction valve capable of being opened and closed toward the upper opening and a lower suction valve capable of being opened and closed toward the lower opening, and
wherein the geothermal heat utilization system is configured such that, when any one of the upper suction valve and the lower suction valve is opened, the other is closed.

2. The geothermal heat utilization system according to claim 1, further comprising:
a water injection pipe that extends from the heat exchanger toward the lower opening,
wherein the well further includes
an upper water injection valve capable of injecting water in the water injection pipe into the upper opening, and
a lower water injection valve capable of injecting water in the water injection pipe into the lower opening.

3. The geothermal heat utilization system according to claim 1, wherein the water chamber further includes an upper surface packer covering an upper surface of the water chamber and a lower surface packer covering a lower surface of the water chamber and is capable of being sealed with respect to at least one of the upper opening and the lower opening.

4. The geothermal heat utilization system according to claim 1, wherein the water chamber further includes an all-surface packer covering all surfaces of the water chamber and is capable of being sealed with respect to at least one of the upper opening and the lower opening.

5. The geothermal heat utilization system according to claim 1, wherein the well further includes an operating rod to which the upper suction valve and the lower suction valve are fixed and which is movable upward and downward.
